(19) United States
(12) Patent Application Publication
(10) Pub. No.: US 2018/0078846 A1
(43) Pub. Date: Mar. 22, 2018

(54) SYSTEM AND METHOD FOR THE PLAY OF WAGERING GAMES

(71) Applicant: LESSINGER GAMING LLC., Alameda, CA (US)

(72) Inventor: Matt Lessinger, Alameda, CA (US)

(73) Assignee: LESSINGER GAMING LLC., Alameda, CA (US)

(21) Appl. No.: 15/669,474

(22) Filed: Aug. 4, 2017

Related U.S. Application Data
(63) Continuation of application No. 13/943,252, filed on Jul. 16, 2013, now abandoned.

(51) Int. Cl. A63F 1/00; G07F 17/32

(52) U.S. Cl. CPC A63F 1/00; A63F 2001/001; G07F 17/3258; G07F 17/3293

(57) ABSTRACT

The present disclosure contains a system and method for conducting a wagering game using playing cards or other game pieces based on the traditional rules of Baccarat and including a Zoo wager and other special wagering options. The wagering game includes special wagering settlement rules, a combination wager and specified payouts. The game is best-suited for play in any Las Vegas style casino or any casino operating under the gaming rules of California and may utilize a computer system or network to enhance or facilitate play of the wagering game.

### CROSS REFERENCE TO RELATED APPLICATIONS

This is a continuation patent application of U.S. patent application Ser. No. 13/943,252, filed Jul. 16, 2013, entitled “SYSTEM AND METHOD FOR THE PLAY OF WAGERING GAMES,” which is incorporated herein by reference in its entirety.

### BACKGROUND OF THE INVENTION

Baccarat is a popular game often played in casino environments. Baccarat may be played as a card table game with a dealing shoe using multiple decks of physical playing cards, or it can be simulated electronically using personal electronic devices, computers and/or the internet.

The present wagering game is suited and for play in any casino or card room. As is well known, Baccarat is usually played on an elongated table including designated wagering areas. Bettor locations are typically numbered on the table and each bettor location has an area designated for a wager on the Banker hand, an area designated for a wager on the Player hand, and an area designated for a wager on the outcome being a tie. A round of Baccarat typically results in the “Player” hand winning, the “Banker” hand winning, or a “Tie” when the hands are valued evenly and neither of the hands win.

One characteristic of conventional Baccarat games is a relatively simple rules set and limited player involvement. Unlike blackjack and other casino wagering games where the player is able to decide when to take additional “hit” cards, in Baccarat, a hit card is dealt automatically in some situations according to the rules of Baccarat. The simplistic nature of the game and the limited number of wagers a player may make tends to limit interest of certain players and thus limits the profit generated by a casino. What is needed is a system and method for providing additional wagering options and exciting features to both attract new players to the Baccarat table and prevent current players from quickly losing interest.

The embodiments described below address the above-described issues and needs.

### SUMMARY OF THE INVENTION

Baccarat is typically played with a limited number of cards. In Baccarat, there are only 2 two-card hands: a Banker hand and Player hand. A player may wager on either the Banker or Player hand achieving a higher total value according to the rules of Baccarat. Each Baccarat hand may receive one additional card in certain circumstances according to the rules of Baccarat.

In Baccarat, the house (one who owns or operates the establishment where the wagering game is being played) or another player may act as the bank for each wager, that is the person or fund against which all wagers are made, regardless of whether the wager is on the banker hand or the player hand. Although Baccarat has a “Banker” hand, the person acting as the “bank” or house is wagering against one or more players, which players may wager on either the Banker or Player hand. A participant may wager on either the Player or Banker hands achieving a higher value. Additionally, the participant may wager that the outcome will be a tie (both hands having the same value). Additionally, the participant may place a Zoo wager which wins in five different scenarios described later in greater detail. The casino takes the other side of the wagers, and collects all losing wagers, paying all winning wagers. Provided herein are methods and systems for playing a modified Baccarat game. In addition to standard Player, Banker, and Tie wagers, the methods and systems provided herein allow players to place special wagers that are paid in certain disclosed circumstances. In some embodiments, the present invention provides a Rabbit wager, a Tiger wager, a Monkey wager, and a combination Zoo wager. In some embodiments, the present invention also provides an electronic display board for recording the result of the hand. In some embodiments, the electronic display board is capable of displaying animations and playing sounds to entertain players and attract new players to the table.

The present invention also discloses software and hardware configurations for carrying out any or all steps of the betting method described herein. It is to be understood the live baccarat game can also be incorporated into an electronic device or an entertainment gaming machine.

### BRIEF DESCRIPTION OF THE DRAWINGS

The foregoing brief description, as well as further objects, features, and advantages of the present disclosure will be understood more completely from the following detailed description of a presently preferred, but nonetheless illustrative embodiment, with reference being had to the accompanying drawings, in which:

FIG. 1 is a flow chart depicting the procedure for conducting the wagering game with one or more players.

FIG. 2 is a table representing the win-conditions for each bonus bet, the name of the bonuses and the payout of the bonuses.

FIG. 3 is a table representing the situations where the Dealer hand will take a third card after the Player hand has taken a third card.

FIG. 4 illustrates an embodiment of a gaming table for use in conducting the wagering game.

FIG. 5 illustrates an electronic scoreboard employed in some embodiments.

FIG. 6 illustrates an electronic payout screen employed in some embodiments.

FIG. 7 is a schematic diagram of the electronic configuration of one embodiment of the gaming system of the present disclosure.

### DETAILED DESCRIPTION

The present disclosure sets forth a system and method for conducting a wagering game played as a live card table game or simulated electronically using personal electronic devices, computers and/or the internet. The present wagering game may be conducted using a single deck of cards but is particularly well-suited for the use of between four and eight standard 52-card decks with no joker cards. Typically multiple decks are shuffled together and placed in a shoe from which the cards are dealt throughout the game. The wagering game includes hand evaluation rules for ranking the hands, with wagering settlement rules and specified payouts in some embodiments. In some embodiments, the disclosed wagering game is a commission-free way to play Baccarat in any Las Vegas style casino. This keeps the game moving at a faster pace, which is both casino-friendly and player-friendly. It also eliminates dealer mistakes in collecting commission, as well as running the risk of having a player leave before paying his commission on winning wagers. In alternative embodiments, where the wagering game takes place in a card room that does not bank the action itself, the dealer will in some cases take a collection fee from each hand before dealing the cards according to house rules.

In Baccarat, the hands are played modulo 10, that is, by comparing the last digit of the total card value. All hands will have a value of between 0 and 9. For example, if a hand has two cards consisting of a 9 and 7, which add up to 16, the hand value is a 6. Aces have a value of 1, and face cards and 10s have a value of 0, unless otherwise specified. A value of 9 is the best hand possible. According to the game rules, the Banker hand and Player hand are initially dealt two cards each and may subsequently draw or “hit” one additional card whose numerical value is added to the first two cards.

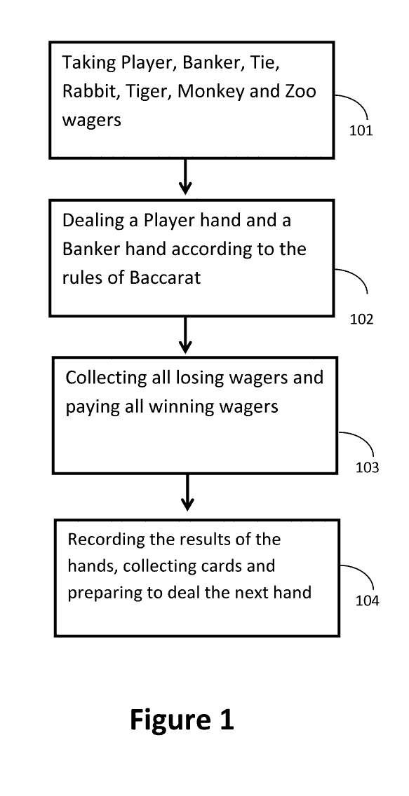

As depicted in FIG. 1, the dealing procedures employed by the present wagering game are unchanged from the common rules of Baccarat. At step 101, players make their Player, Banker, Tie, Rabbit, Tiger, Monkey, and Zoo wagers, or any combination thereof. If the game is being played in a casino or card room that does not bank the action itself, the dealer will optionally take a collection fee from each hand before dealing the cards according to house rules. At step 102, the dealer will deal the hands and determine the winning and losing wagers. At step 103, the dealer will collect all losing wagers in the center of the table and then pay all winning wagers. At step 104, the dealer will record the result of the hands before collecting the cards and preparing to deal the next hand.

A player may make any combination of the following: Player wager, Banker wager, Tie wager, Rabbit wager, Tiger wager, Monkey wager, and Zoo wager. A Player wager wins when the Player ends the hand with the higher point total. Player wagers will be paid even money. If the result is a tie, Player bets will push. If Banker has the higher point total, Player bets will lose. A Banker wager wins when the Banker ends the hand with the higher point total. Banker wagers will be paid even money, with one exception. If Banker wins with a hand comprised of three cards and a point total of eight, Banker bets will push. If the result is a tie, Banker bets will again push. If Player has the higher point total, Banker bets will lose. A Tie wager wins when Player and Banker end the hand with identical point totals. Tie wagers will be paid 9 to 1. If either Player or Banker wins, Tie bets lose.

A novel aspect of the present invention is the inclusion of special wagers. These bets provide new ways for players to wager on the outcome of the Player and Banker hands. Specifically, the Zoo bet is designed to provide a relatively frequent bonus payout to keep players in the action for a longer period of time. The inclusion of these special wagering options adds complexity and excitement to an otherwise basic wagering system.

The Zoo bet allows players to win in five different ways by making only one bonus bet. Most other Baccarat variations offer bonus bets with only one way to win. The inclusion of Zoo bets provides more opportunities for players to win even when the first two cards do not seem to be in their favor. This will keep them more interested in the action from start to finish. The Zoo wager will hit 6.245% of the time. Contrast this to a popular variation such as EZ Baccarat, where the bonus bet hits only 2.253% of the time. More frequent bonus payouts keep players in action for a longer period of time. They also lessen the long frustrating stretches of playing entire shoes without hitting a bonus payout, stretches which often make a customer decide to end their playing session. If they wish, players will be allowed to place the Zoo wager, Rabbit wager, Tiger wager, Monkey wager or Tie bet without making a Player or Banker wager. So for the times when they do not have a strong inclination towards betting Player or Banker, they can still make a wager that will keep them very interested in the outcome.

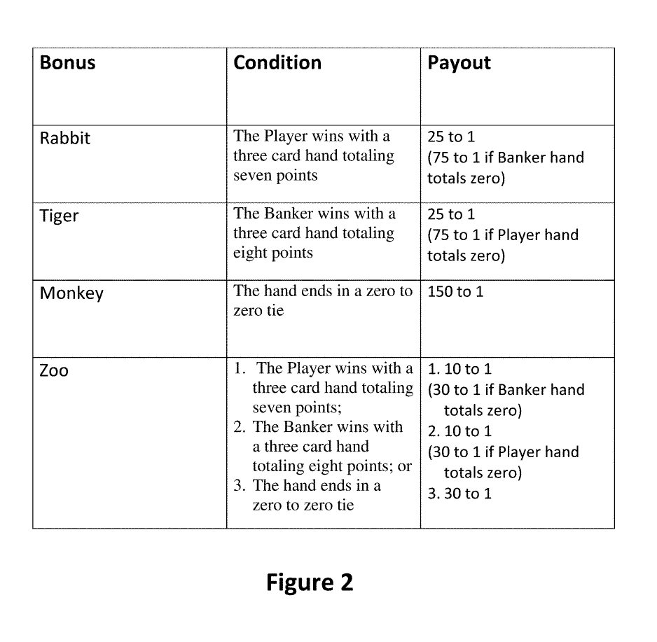

As depicted in FIG. 2, four types of special wagers may be placed by a participant. The special wagers are as follows:
1. A Rabbit wager wins when Player wins with a three card hand totaling seven points. and will be paid 25 to 1. If the Rabbit bonus wins and the Banker hand totals zero, the payout is tripled (i.e., to 75 to 1). Rabbit wagers lose with any outcome other than Player winning with a three-card hand totaling seven points.
2. A Tiger wager wins when Banker wins with a three card hand totaling eight points, and will be paid 25 to 1. If the Tiger bonus wins and the Player hand totals zero, the payout is tripled (i.e., to 75 to 1). Tiger wagers lose with any outcome other than Banker winning with a three-card hand totaling eight points.
3. A Monkey wager wins when the hand ends in a zero to zero tie and will be paid 150 to 1. Monkey bets lose with any result other than a zero to zero tie.
4. A Zoo wager is a combination wager that wins if any one of the Rabbit, Tiger or Monkey wagers win. The payout varies depending on which wager wins. If the Rabbit bonus wins and the participant has placed a Zoo wager, the payout is 10 to 1. If the Rabbit Bonus wins and the Banker hand totals zero, the Zoo wager payout is tripled to 30 to 1. If the Tiger bonus wins and the participant has placed a Zoo wager, the payout is 10 to 1. If the Tiger wins and the Player hand totals zero, the Zoo wager payout is tripled to 30 to 1. If the Monkey bonus wins and the player has placed a Zoo wager, the payout is 30 to 1.

Participants can wager on the Rabbit, Tiger, and Monkey wagers individually and combined as a Zoo wager. This wagering scheme gives the participant a total of seven possible wagers: Player hand, Banker hand, Tie, Rabbit wager, Tiger wager, Monkey wager, Zoo wager, or any combination thereof. One set of table limits will apply to Player and Banker bets, and a second set of table limits will apply to all other bets.

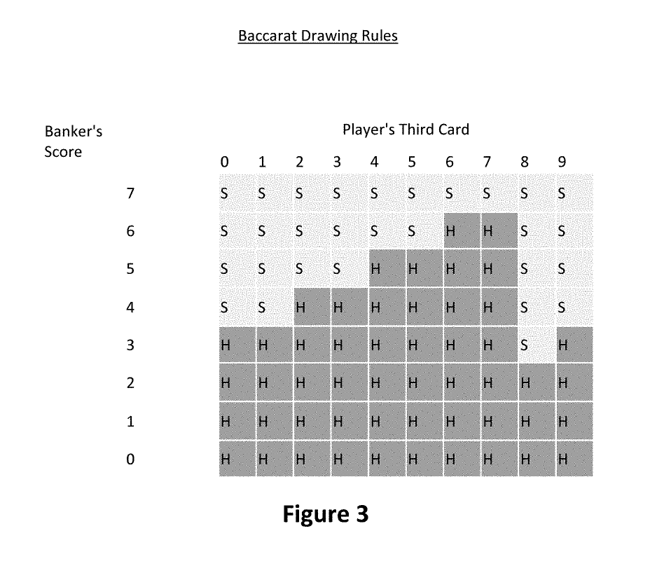

The standard Baccarat drawing rules are well known. According to the game rules, the Banker hand and Player hand are initially dealt two cards each and may subsequently draw or “hit” one additional card whose numerical value is added to the first two cards. According to the rules, if either Player or Banker has a point total of eight or nine on their first two cards, they both stand (meaning they do not take a hit card). This overrides all other hitting rules. If Player has a point total of six or seven, Player stands. Banker will take a card if Banker has a point total of five or less. If Player has a point total of five or less, Player receives a third card. FIG. 3 represents the standard Baccarat drawing rules for determining when the banker hand will take a third card based on the Banker's current score and the value of the Player's third card.

In some embodiments, an electronic display board, including a visual component and an audio component is featured near the gaming table. The animations and sound effects produced by the display board will foster a gaming environment that is livelier than standard Baccarat. The electronic scoreboard comprises an input device for receiving display data from a computer or other source, a processor for processing input data and generating scores, and a display unit for displaying images, scores and animations.

In some embodiments featuring an electronic scoreboard, when the Rabbit wager hits, the electronic scoreboard will have an animated rabbit appear with sound effects. Likewise, when the Tiger wager hits a tiger will appear, and when the Monkey wager hits a monkey will appear. This will generate interest from passersby, some of whom might stop and play the wagering game when they would have otherwise passed by.

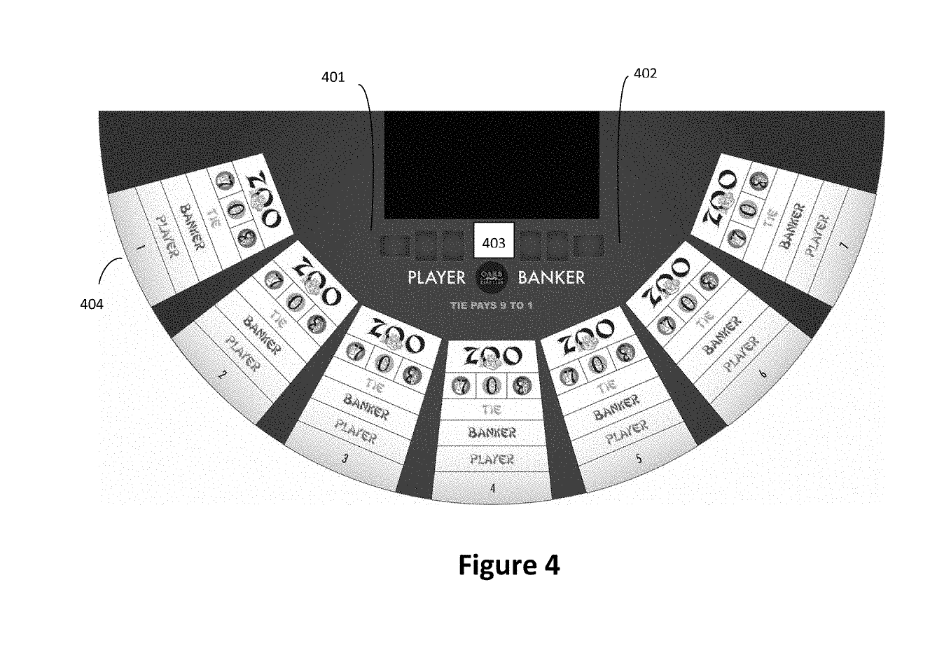

The present wagering game is well-suited for play on either a standard mini-baccarat table or a standard big baccarat table. FIG. 4 illustrates an embodiment of a gaming table surface for use in the combined play of wagering games. The player Baccarat cards are placed on the player Baccarat region 401 and the banker Baccarat cards are placed on the banker Baccarat region 402. The casino or game designation region 403 is centrally located on the surface of the table between the player Baccarat region 401 and banker Baccarat region 402. Around the perimeter of the table surface are several numbered player regions 404 (e.g., seven are shown in FIG. 4). Each player region provides designated wagering areas for the Player wager, the Banker wager, the Tie wager, the Rabbit wager, the Tiger wager, the Monkey wager and the Zoo wager.

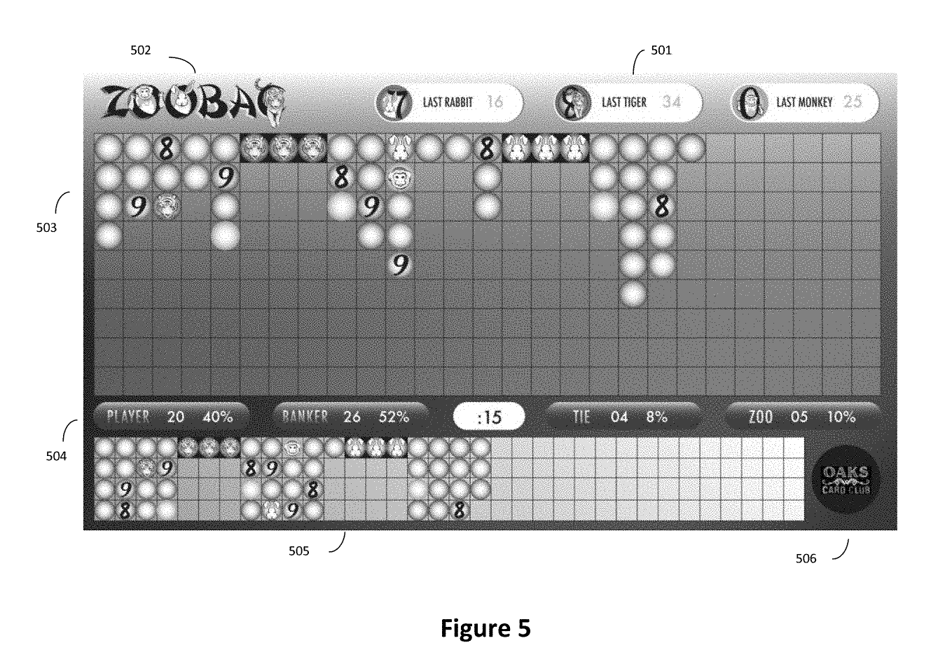

FIG. 5 provides a graphic representation of an electronic scoreboard employed in some embodiments. The game logo 502 is located in the upper-left corner and the casino or house logo 506 is located in the bottom-right corner. At the top of the screen and to the right of the game logo is the special wager tracking area 501. The special wager tracking area features a separate counter for the Rabbit, Tiger and Monkey wagers. Each hand that is played without hitting a Rabbit, Tiger or Monkey wager increases the respective counter by one. When one of the special wagers eventually hits, that particular counter is reset to zero. The bottom of the screen comprises large-scale grid 505 for keeping track of hand outcomes over a long period of time. Hands that resulted in a special wager payout are indicated by displaying the corresponding special wagers logo (rabbit, tiger or monkey). Above the large-scale grid is outcome tracking area 504. The outcome tracking area features separate counters indicating how many times the player hand has won, how many times the banker hand has won, how many times the hand-outcome has been a tie and how many times the zoo wager has won. Next to the counter is a number indicating the frequency of the occurrence. Above the outcome tracking area in the center of the screen is main display grid 503 for keeping track of hand outcomes over a short period of time.

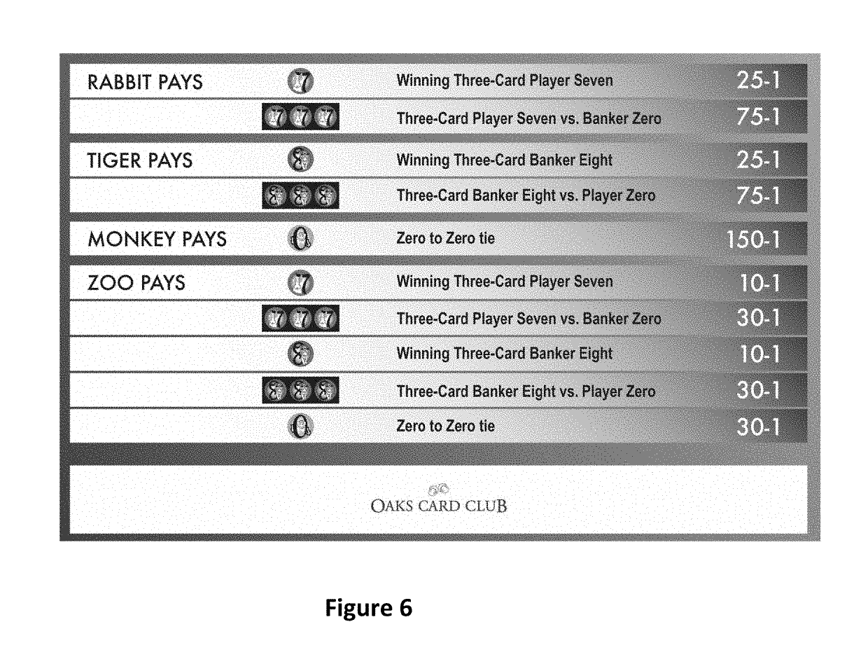

FIG. 6 provides a graphic representation of a payout screen employed in some embodiments. The payout screen indicates the name, winning conditions and payout associated with each special wager.

In some embodiments, a progressive jackpot is maintained from hand to hand and pays under certain conditions. In one particular embodiment, the progressive jackpot pays when the Player hand totals zero and is beaten by a Banker hand of three sixes.

In alternative embodiments, for any part of the game, dice, tiles or other gaming indicia are substituted for playing cards.

In alternative embodiments, some or all of the cards are concealed from other players.

In alternative embodiments, there are one or more players who are not physically present at the table.

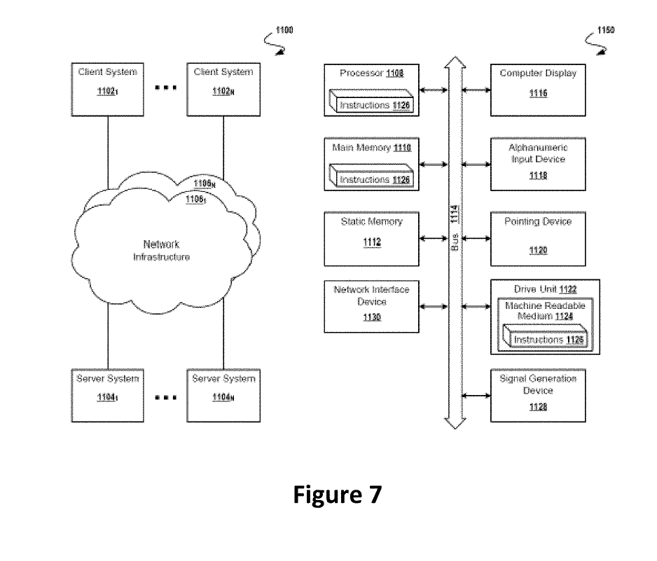

In alternative embodiments, all or part of the game is conducted using at least one computer system. FIG. 7 is a block diagram 1100 of a computer system for implementing embodiments of the platform. The computer system includes nodes for client computer systems 11021 through 1102N, nodes for server computer systems 11041 through 1104N, and nodes for network infrastructure 11061 through 1106N, any of which nodes may comprise a machine (e.g. computer 1150) within which a set of instructions for causing the machine to perform any one of the techniques discussed above may be executed. The embodiment shown is purely exemplary, and might be implemented in the context of one or more of the figures herein.

Any node of the network may comprise a general-purpose processor, a digital signal processor (DSP), an application specific integrated circuit (ASIC), a field programmable gate array (FPGA) or other programmable logic device, a discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems (including a processor and memory), a massively parallel computer system, and/or a cloud computer system.

The computer system (e.g. computer 1150) includes a processor 1108 (e.g. a processor core, a microprocessor, a computing device, etc.), a main memory (e.g. computer memory 1110), and a static memory 1112, which communicate with each other via a system bus 1114. The computer 1150 may further include a display unit (e.g. computer display 1116) that may comprise a touch-screen, or a liquid crystal display (LCD), or a light emitting diode (LED) display, or a cathode ray tube (CRT). As shown, the computer system also includes a human input/output (I/O) device 1118 (e.g. a keyboard, an alphanumeric keypad, etc.), a pointing device 1120 (e.g. a mouse, a touch screen, etc.), a drive unit 1122 (e.g. a disk drive unit, a CD/DVD drive, a tangible computer readable removable media drive, an SSD storage device, etc.), a signal generation device 1128 (e.g. a speaker, an audio output, etc.), and a network interface device 1130 (e.g. an Ethernet interface, a wired network interface, a wireless network interface, a propagated signal interface, etc.).

The drive unit 1122 includes a machine-readable medium 1124 on which is stored a set of instructions (i.e. software, firmware, middleware, etc.) 1126 embodying any one, or all, of the methodologies described above. The set of instructions 1126 is also shown to reside, completely or at least partially, within the main memory and/or within the processor 1108. The set of instructions 1126 may further be transmitted or received via the network interface device 1130 over the system bus 1114.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing non-transitory information in a form readable by a machine (e.g. a computer). For example, a machine-readable medium includes read-only memory (ROM); random access memory (RAM); magnetic disk storage media; optical storage media; flash memory devices; and electrical, optical or acoustical or any other type of media suitable for storing non-transitory information.

Although the present disclosure has been described in terms of specific exemplary embodiments, it will be appreciated that various modifications and alterations might be made by those skilled in the art without departing from the spirit and scope of the invention. While many embodiments have been described, it is to be understood that different embodiments may be combined in various ways and are not considered mutually exclusive.

What is claimed is:

1. A method for implementing a casino wagering game, the method comprising:
executing, on a processor, computer readable instructions that direct the processor to perform:
providing, to one or more participants, betting areas for a standard player wager, a standard banker wager, and non-standard wagers including a Rabbit wager, a Tiger wager, a Monkey wager, and a Zoo wager, wherein the Zoo wager is a combination of the Rabbit wager, the Tiger wager, and the Monkey wager;
providing playing cards, each of the playing cards having a numerical point value;
providing a predetermined rule for resolving the Rabbit wager which provides that the Rabbit wager wins if Player wins with a three card hand totaling seven points;
providing a predetermined rule for resolving the Tiger wager, which provides that the Tiger wager wins if Banker wins with a three card hand totaling eight points;
providing a predetermined rule for resolving the Monkey wager, which provides that the Monkey wager wins if the hand ends in a zero to zero tie;
providing a predetermined rule for resolving the Zoo wager, which provides that Player wins with a three card hand totaling seven points, Banker wins with a three card hand totaling eight points, or the hand end in a zero to zero tie; and
dealing a player's hand and a banker's hand including a third card in some situations according to predetermined baccarat rules.

2. The method for implementing a casino wagering game of claim 1, further comprising:
offering the one or more participants an opportunity to place any combination of the standard player wager, the standard banker wager, a standard tie wager, the Rabbit wager, the Tiger wager, the Monkey wager, and the Zoo wager;
resolving any of the standard wagers according to the predetermined baccarat rules; and resolving any of the non-standard wagers according to the corresponding predetermined rules for resolving the non-standard wagers.

3. The method for implementing a casino wagering game of claim 1, further comprising:
providing an electronic scoreboard including speakers and a display surface configured to play prerecorded sounds and animations when the Zoo wager wins.

4. The method for implementing a casino wagering game of claim 1, further comprising:
paying the Rabbit wager 25 to 1 when Player wins with a three card hand totaling seven points, unless the banker's hand totals zero points, in which case the Rabbit wager is paid 75 to 1;
paying the Tiger wager 25 to 1 when Banker wins with a three card hand totaling eight points, unless the player's hand totals zero points, in which case the Tiger wager is paid 75 to 1;
paying the Monkey wager 150 to 1 when the hand ends in a zero to zero tie; and
paying the Zoo wager:
a) at 10 to 1 when Player wins with a three card hand totaling seven points,
b) at 30 to 1 when Player wins with a three card hand totaling seven points and Banker has zero,
c) at 10 to 1 when Banker wins with a three card hand totaling eight points,
d) at 30 to 1 when Banker wins with a three card hand totaling eight points and Player has zero, and
e) at 30 to 1 when the hands end in a zero to zero tie.

5. The method for implementing a casino wagering game of claim 1, wherein providing the playing cards comprises:
providing no more than eight standard 52-card decks, no fewer than 4 standard 52-card decks, and no joker cards.

6. The method for implementing a casino wagering game of claim 1, wherein the Zoo wager provides reduced payout ratios for winning Rabbit, Tiger, and Monkey wagers than corresponding payout ratios for resolving separate Rabbit, Tiger, and Monkey wagers.

7. The method for implementing a casino wagering game of claim 1, wherein the resolutions of Rabbit, Tiger, and Monkey wagers are based on both the player's hand and the banker's hand.

8. The method for implementing a casino wagering game of claim 1, wherein the standard player wager and the standard banker wager are defined in the predetermined baccarat rules and the Rabbit, Tiger, and Monkey wagers are not defined in the predetermined baccarat rules.

9. The method for implementing a casino wagering game of claim 1, further comprising:
accepting a wager, wherein the accepted wager may include only one or more of the non-standard wagers.

10. A method for implementing a casino wagering game, the method comprising:
executing, on a processor, computer readable instructions that direct the processor to perform:
providing, to one or more participants, betting areas for standard baccarat wagers and non-standard wagers, the standard baccarat wagers including a player wager and a banker wager, and the non-standard wagers including a Rabbit wager, a Tiger wager, a Monkey wager, and a Zoo wager;
providing playing cards, each of the playing cards having a numerical point value;
providing a predetermined rule for resolving the Rabbit wager which provides that the Rabbit wager wins if Player wins with a three card hand totaling seven points;
providing a predetermined rule for resolving the Tiger wager, which provides that the Tiger wager wins if Banker wins with a three card hand totaling eight points;
providing a predetermined rule for resolving the Monkey wager, which provides that the Monkey wager wins if the hand ends in a zero to zero tie;
providing a predetermined rule for resolving the Zoo wager, which provides that Player wins with a three card hand totaling seven points, Banker wins with a three card hand totaling eight points, or the hand end in a zero to zero tie;
accepting a wager, wherein the accepted wager may include only one or more of the non-standard wagers; and
dealing a player's hand and a banker's hand including a third card in some situations according to predetermined baccarat rules.

11. The method for implementing a casino wagering game of claim 10, further comprising:
offering the one or more participants an opportunity to place any combination of the standard player wager, the standard banker wager, a standard tie wager, the Rabbit wager, the Tiger wager, the Monkey wager, and the Zoo wager;
resolving any of the standard wagers according to the predetermined baccarat rules; and resolving any of the non-standard wagers according to the corresponding predetermined rules for resolving the non-standard wagers.

12. The method for implementing a casino wagering game of claim 10, further comprising:
providing an electronic scoreboard including speakers and a display surface configured to play prerecorded sounds and animations when the Zoo wager wins.

13. The method for implementing a casino wagering game of claim 10, further comprising:
paying the Rabbit wager 25 to 1 when Player wins with a three card hand totaling seven points, unless the banker's hand totals zero points, in which case the Rabbit wager is paid 75 to 1;
paying the Tiger wager 25 to 1 when Banker wins with a three card hand totaling eight points, unless the player's hand totals zero points, in which case the Tiger wager is paid 75 to 1;
paying the Monkey wager 150 to 1 when the hand ends in a zero to zero tie; and
paying the Zoo wager:
a) at 10 to 1 when Player wins with a three card hand totaling seven points,
b) at 30 to 1 when Player wins with a three card hand totaling seven points and Banker has zero,
c) at 10 to 1 when Banker wins with a three card hand totaling eight points,
d) at 30 to 1 when Banker wins with a three card hand totaling eight points and Player has zero, and
e) at 30 to 1 when the hand end in a zero to zero tie.

14. The method for implementing a casino wagering game of claim 10, wherein the Zoo wager provides reduced payout ratios for winning Rabbit, Tiger, and Monkey wagers than corresponding payout ratios for resolving separate Rabbit, Tiger, and Monkey wagers.

15. The method for implementing a casino wagering game of claim 10, wherein the resolutions of Rabbit, Tiger, and Monkey wagers are based on both the player's and the banker's hands.

16. The method for implementing a casino wagering game of claim 10, wherein the standard player wager and the standard banker wager are defined in the predetermined baccarat rules and the Rabbit, Tiger, and Monkey wagers are not defined in the predetermined baccarat rules.

17. The method for implementing a casino wagering game of claim 10, wherein the Zoo wager is a combination of the Rabbit wager, the Tiger wager, and the Monkey wager.

18. A gaming device, comprising:
a memory storing:
standard rules for resolving a standard player wager and a standard banker wager; and
non-standard rules for resolving non-standard wagers that include a Rabbit wager, a Tiger wager, a Monkey wager, and a Zoo wager, the Zoo wager being a combination of the Rabbit wager, the Tiger wager, and the Monkey wager; and
a processor coupled to the memory and configured to:
accept a wager;
deal a player's hand and a banker's hand, the player's hand and the banker's hand including playing cards, wherein each of the playing cards has a numerical point value; and
resolve the wager according to the standard rules and the non-standard rules, wherein:
the Rabbit wager wins if the player's hand wins with a three card hand totaling seven points;
the Tiger wager wins if the banker's hand wins with a three card hand totaling eight points;
the Monkey wager wins if the player's hand and the banker's hand end in a zero to zero tie; and
the Zoo wager wins if one or more of: the Rabbit wager, the Tiger wager, and the Monkey wager results in a winning resolution.

19. The gaming device of claim 18, wherein the Zoo wager provides reduced payout ratios for winning Rabbit, Tiger, and Monkey wagers than corresponding payout ratios for resolving separate Rabbit, Tiger, and Monkey wagers.

20. The gaming device of claim 18, wherein the accepted wager may include only one or more of the non-standard wagers.
